(19) United States
(12) Patent Application Publication
(10) Pub. No.: US 2004/0099823 A1
(43) Pub. Date: May 27, 2004

(54) Device for inspecting and testing a single glass pane, an insulating glass element or a laminated glass

(76) Inventors: Gerhard Abraham, Wien (AT); Wolfgang Krob, Moldling (AT); Robert Vonasek, Wien (AT)

Correspondence Address: DRINKER BIDDLE & REATH, ONE LOGAN SQUARE, 18TH AND CHERRY STREETS, PHILADELPHIA, PA, 19103-6996, US

(21) Appl. No.: 10/399,815

(22) PCT Filed: Jul. 23, 2001
(86) PCT No.: PCT/AT01/00252

(30) Foreign Application Priority Data
Oct. 23, 2000 (AT) A 1816/2000

(51) Int. Cl. G01N 21/86

(52) U.S. Cl. 250/559.4

(57) ABSTRACT

The invention relates to a device for inspecting and testing a single glass pane, an insulating glass element (41, 42, 43), which comprises two or more parallel glass panes, or a laminated glass (70, 71, 72). The inventive device comprises a first light source (2) whose optical axis can be brought into a reflection position with the test object and comprises an optical unit for determining the distance between the reflected parallel light beams (11, 12, 13, 14, 15, 16). Said optical unit is formed by a local resolution opto-electronic detector (3) that is connected to an evaluation device (45). Said evaluation device determines, from the distances between and the intensities of the reflected light beams (11, 12, 13, 14, 15, 16), the thickness of the single glass pane, the thickness of the individual glass panes of the insulating glass element (41, 42, 43) or the thickness of the layers of the laminated glass (70, 71, 72) and the distances therebetween and/or the presence and the location of coatings (50), which are applied to the single glass pane or to the individual glass panes of the insulating element (41, 42, 43), or of one or more laminated films (71) contained in the laminated glass (70, 71, 72).

The invention relates to a device for inspecting and testing a single glass pane, an insulating glass element comprising two or more parallel glass panes, for example, an insulating window, or a laminated glass, with a first light source, whose optical axis can be brought into a reflection position with the single glass pane, the insulation glass element, or the laminated glass and an optical unit fixedly arranged opposite thereto for determining the reciprocal distance of the parallel light beams reflected from the single glass pane, the insulating glass element, or the laminated glass.

With the device known from WO 99/58928 A, the thickness of the glass pane of an insulating glass element is determined by laser triangulation, whereby the opposite distance of the laser beams reflected from the glass panes can be measured with the assistance of a measuring rod. The measuring error, conditional on the blurring of the light points produced by the reflected light beams, makes possible only a relatively inaccurate thickness and distance determination of the insulating glass element. The availability of a coating on the glass panes can not be ascertained with this known device.

In particular, before and during the erection of buildings, however, it is especially important to inspect and test the quality and the functional efficiency of the glass panes and insulating glass elements. In addition to the determination of the accurate actual thickness and the accurate actual reciprocal distance of the glass panes, the inspection of the correct position of a coating on one or the other side of the glass pane is of greater importance for its heat technology function. The position of the coating on the glass pane or on the insulating glass element can not be determined with the naked eye. Until now, also common destructive inspection of the glass is connected with great expense and can only be performed by spot tests.

A further method for assessing a coating on an insulating glass element exists in the capacitive measurement itself. This, however, is only possible up to a determined thickness of the insulating glass element and the measuring device suited therefor must always lie upon the respective coated pane of the insulating glass element, which is not always possible when this, for example, is on the outside of a building.

Likewise, until now, it has only been with a very great relative expense that it has been possible with a laminated glass to determine the thickness and the existence of a laminate film.

An object of the invention, therefore, is to provide a device of the above-described type, with which a damage-free inspection of the position of the existing coating or laminate foil on a single glass pane, the glass panes of an insulating element or within a laminated glass, as well as a thickness measurement of the coating or the laminate foil, is possible.

A further object of the present invention is to design the device to be portably, easily manageable, and user safe.

According to the present invention this is achieved in that the optical unit for determination of the reciprocal distance of the reflected light beams is formed by means of a position-resolving, opto-electronic detector, which is connected with an evaluation device, which, from the distances and intensities of the reflected light beams, determines the thickness of the single glass pane, the thickness of the individual glass panes of the insulating glass element, or the thickness of the layers of the laminated glass and its reciprocal distance and/or the existence and position of the coating applied to the single glass pane or the individual glass panes of the insulating glass element or of one or more laminate films contained in the laminated glass.

The use of an opto-electronic detector makes possible an accurate measurement of the mutual distance of the beams reflected from the single pane, the insulating glass element, or the laminated glass, since from the intensity dispersion of the reflected beams, the determination of the intensity maximum can take place, which makes possible a very accurate distance determination. With its help, the thickness of the glass panes and also the thickness of the laminate film can be determined.

By evaluation of the reflected intensity, also reliable statements about the presence of coatings or of laminate films and their positions on the individual insulating glass panes or in the laminate glass can be reconciled.

In further embodiments of the invention, it can be provided that in a separating distance from the first light source, a transport device is arranged, on which the single glass panes, insulating glass element or laminated glass are movable, so that during the passing movement of the single glass pane, the insulating glass element or the laminated glass to the first light source, this arrives in the reflection position and the reflected light beams impinge on the opto-electronic detector.

The glass panes moved past in a defined distance can be measured during their movement and inspected, without having to stop for this purpose.

Another variation of the invention provides that the device is arranged in a housing that can be attached to one of the outer sides of the single glass pane, the insulating glass element, or the laminated glass, whereby in the housing, at least one first perforation is provided for passing through of the light beam that can be sent out from the first light source and the light beams reflected from the single glass pane, the insulating glass element, or the laminated glass.

In this manner, it can already be inspected in the window frame or in the glass panes built into building parts whether a coating or a laminate foil is provided in or on these elements. The housing can be attached on the outside of the glass pane and then take the measurement.

A substantially standardized measurement and evaluation of the reflected light beams can be seen according to a further embodiment of the invention, in which the opto-electronic detector is formed as a CCD (Charge Coupled Device) element containing a plurality of image storage points, and in which the light beams reflected from the single glass pane, from the insulating glass element or from the laminated glass impinge on the image storage points.

Since the reflected light beams should run to their distortion-free measurement in a normal plane to the insulating glass pane to be measured, in a further embodiment of the invention, it is provided that the CCD element is embodied as a CCD line, in which the image storage points are arranged linearly along the longitudinal axis of the CCD line, and that the longitudinal axis of the CCD line runs in the plane extending through the reflected light beams.

An advantageous embodiment of the invention for the practical use and for the making of the inventive device provides that the at least one first perforation for the passage of the light beam that can be sent from the first light source and the light beams reflected back from the single glass pane, from the insulating glass element, or from the laminated glass—in a known manner—is excepted or selected in a housing wall on the underside of the housing and that the optical axis of the first light source runs relative to the housing wall, preferably in an angular range of 45° to 60°.

A very compact structure of the inventive device in a further variation of the invention provides that the first light source is embodied as a laser diode.

According to a further embodiment of the invention, it can be provided that the first wall perforation is has a rectangular shape and that the CCD line is arranged along the longitudinal central axis of the first wall perforation and vertically offset to the housing wall forming the wall perforation.

In this manner, many side-by-side, spaced, reflected light beams can be measured, so that also insulating glass elements with multiple glass panes and relative large mutual spaced distance can be inspected.

A further embodiment of the invention provides that the evaluation device is connected with a display device, by means of which the number, the thickness, the mutual distance of the parallel glass panes and the position of a likewise provided coating on the front or back side of the single glass pane or the glass panes of the insulating glass element or the number and thickness of the laminate film of the laminated glass can be displayed.

The display device makes possible a clear and fast representation of the measurement results.

In order to stop effects on the measurement results from glare, another embodiment of the present invention provides that in a distance from the CCD line, an interference filter is arranged, as viewed in the direction of the reflected beams, which is permeable in consideration of the angle of incidence of the reflected beams only for the wave length of the light that can be sent from the first light source. In this manner, practically only light with the wave length emitted from the first light source arrives in the opto-electronic detector, whereby a very accurate intensity determination of the reflected beams is possible.

A further reduction of the effects of glare allows, in a further embodiment of the invention, that the thickness of the housing wall on the underside of the housing is greater than the opening width of a wall perforation for passage of the light beams that are reflected back.

Of the light from outside of the inventive device that falls at an incline on the perforation from the surroundings of the glass pane or the insulating glass element, large parts can be prevented from entering through the perforation, or the glare is absorbed on the perforation wall.

Further, the invention relates to a device for inspecting and testing a single glass pane, an insulating glass element having two or more parallel glass panes, for example, an insulating glass window, or a laminated glass.

Known device of this type makes possible only the thickness determination of glass panes, for example, an insulating glass element, however, not an inspection of the internal structure of the glass, which also represents an essential quality criterion. Already, proposals for inspection of a glass pane, an insulating glass element, or a laminated glass exists, in order to determined if these components are hardened or not. One of these solutions demanded, however, a very labored procedure for the observer, in which an optical sampling with a bundled light beam is made. With a further determination method, the glass must be accessible from the side, which in many cases is not possible (for example, with glass panes which are already built into a building).

An object of the present invention is to provide a device of the above-described type, which makes possible a simple and comfortable structural testing, in addition to a thickness determination of single and multi-layered (insulating) glass panes, which requires no exhausting testing steps by the observer.

According to the present invention, this is achieved in that a second light source for emitting a planar light field and first light polarization device, as well as a second light polarization device are provided, whereby the first light polarization device polarizes the light emitted from the second light source and the second light polarization device polarizes the light reflected from the single glass pane, from the insulating glass element, or from the laminated glass.

The light field observed under polarized light, by means of the light-dark contrast, provides at a glance information about the structure formed by glass hardening and therewith, information about the presence of hardened or unhardened glass.

Furthermore, it can be provided that a transport device is arranged at a distance from the second light source, on which the single glass pane, insulating glass element, or laminated glass are moveable, so that during the passing movement of the individual glass pane, the insulating glass element, or the laminated glass, the light field that can be emitted from the second light source impinges on the glass surface.

In this manner, a test of the state of the glass quality can be performed during the transport movement of the glass panes, whereby the movement can be utilized in order to move the entire surface of the glass with the inventive device. The observation of the reflected light can be automated.

In a further embodiment of the invention, it can be provided that the device includes a housing that can be attached on one of the outer sides of the single glass pane, the insulating glass element, or the laminated glass, that the housing has at least a second perforation for passage of the planar light field that can be emitted from the second light source and the first light-polarization device is arranged in an area of the second light source, and that a housing window is provided that is directed at the second housing perforation, in which region a second light-polarization device is arranged.

The device accommodated in the housing can be attached on a built-in glass element and the state of the glass surface can be completely appraised by shifting or displacing the housing.

A further embodiment of the invention provides that the second light source is formed as a preferably U-shaped fluorescent tube. In this manners a very uniform illumination of the light field impinging on the insulating glass element can be achieved.

A technically simple and realizable variation of the invention provides that the first light-polarization device is formed by a first pole filter and the second light-polarization device is formed by a second pole filter.

In a further embodiment of the invention, testing of an insulating glass element or a laminated glass that is very comfortable and clear for the observer can be performed, in which the housing window is formed in an appointed housing wall in an oblique angle, preferably 45°, and the second pole filter is countersunk in a first frame part running parallel to the housing window.

In a further embodiment of the invention, it can be provided that in the interior of the housing, a second frame part for receiving the first pole filter is arranged, whose plane preferably is oriented at a right angle to the first frame part, so that the first and the second frame part extend in the manner of a roof over the second perforation.

In this manner, a stable and symmetrical positioning of the light-polarization devices within the housing is achieved.

A polarization that is uniform over the entire light field, according to another embodiment of the invention, can be achieved in that the fluorescent tube extends parallel to the plane of the second frame part.

Next, the invention will be described with referenced to the embodiments shown in the accompanying drawings.

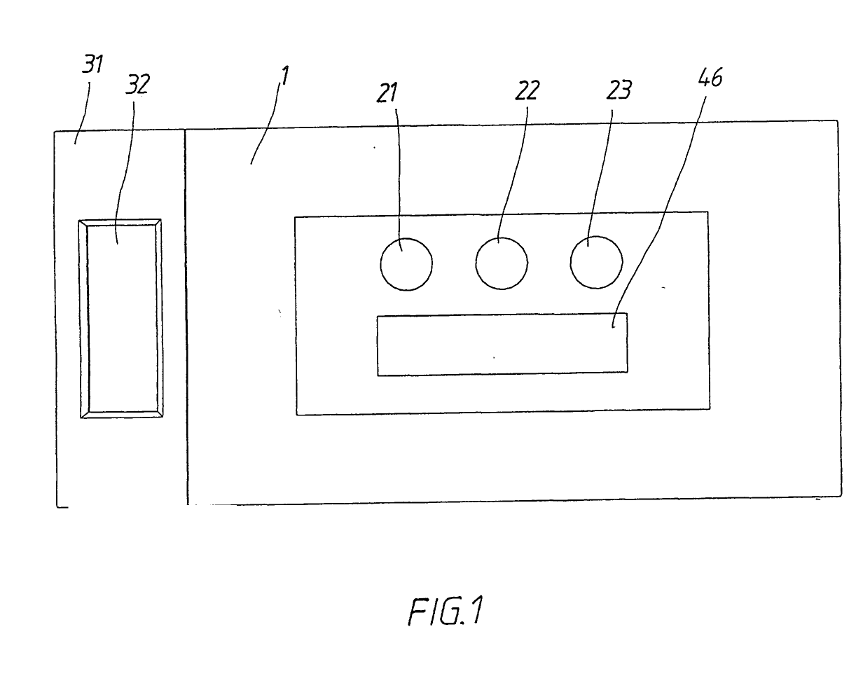

FIG. 1 is a plan view on the housing of one embodiment of the device of the present invention;

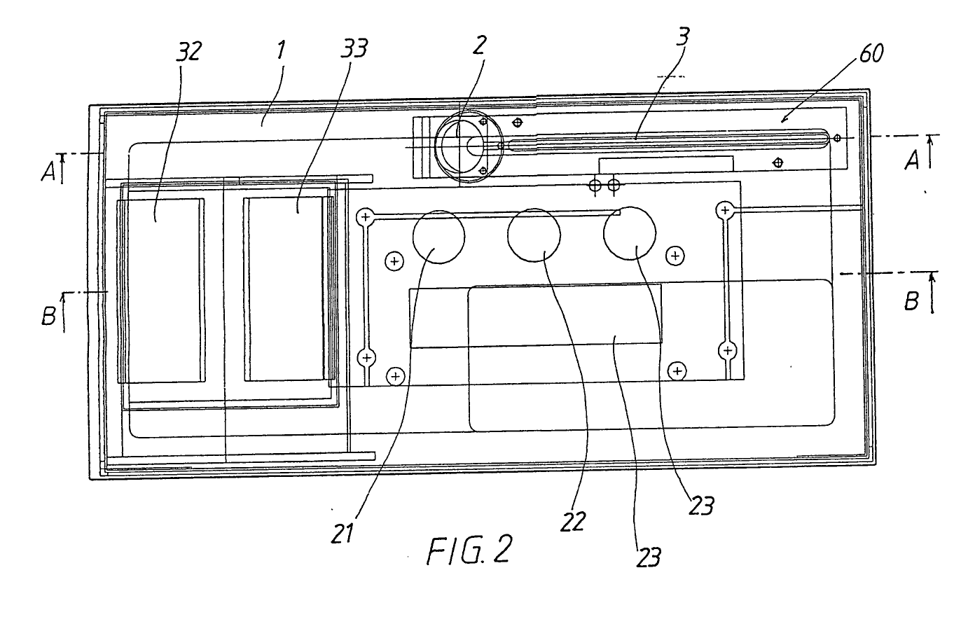

FIG. 2 is a plan view on the opened housing according to FIG. 1;

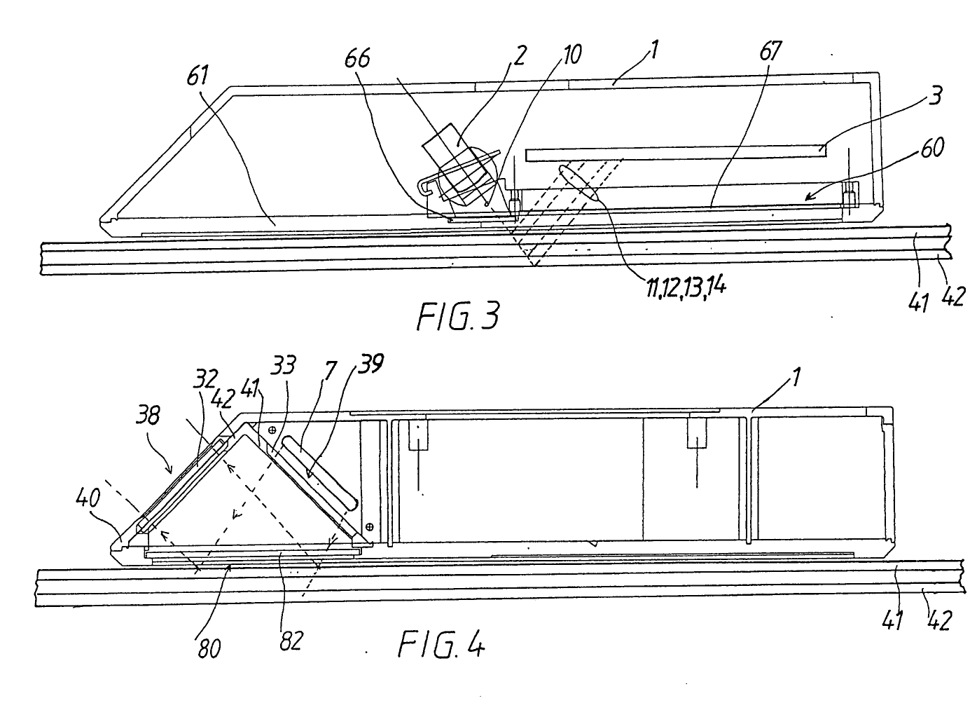

FIG. 3 is a section AA through the housing according to FIG. 2;

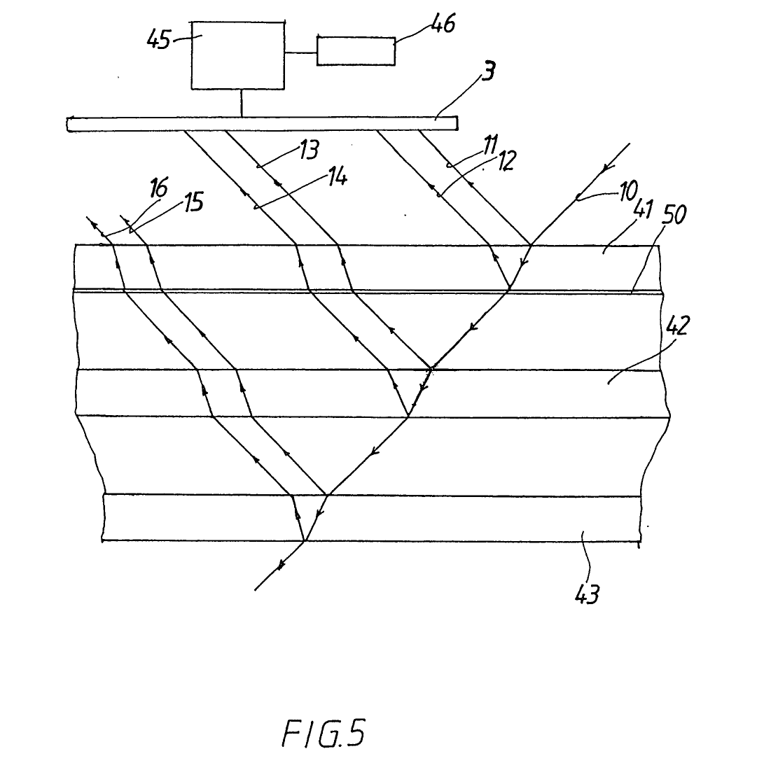

FIG. 4 is a section BB through the housing according to FIG. 2;

FIG. 5 is a schematic representation of the optical path through an insulating glass element and a further embodiment of the device according to the present invention;

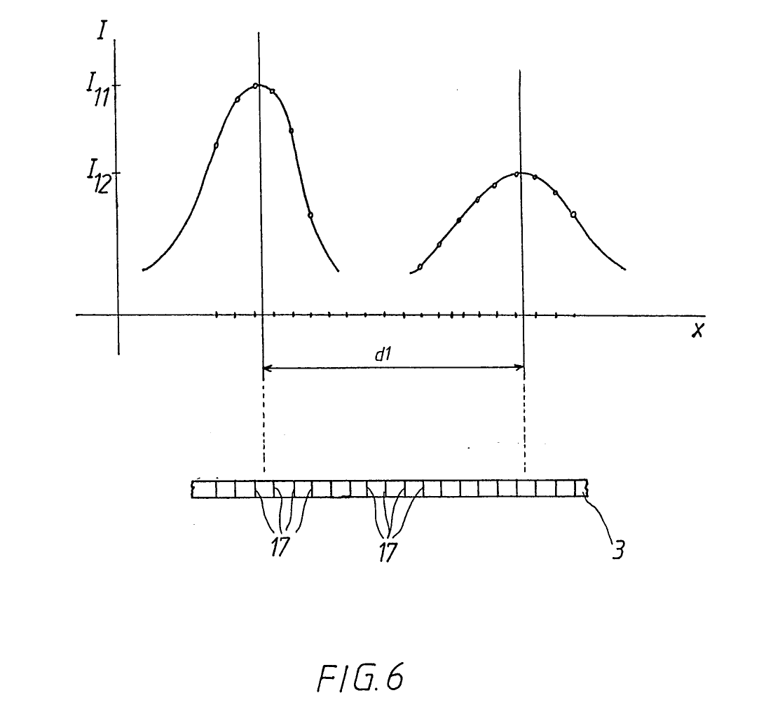

FIG. 6 is a schematic representation of the intensity dispersion of beams reflected from a pane of an insulating glass element according to FIG. 5;

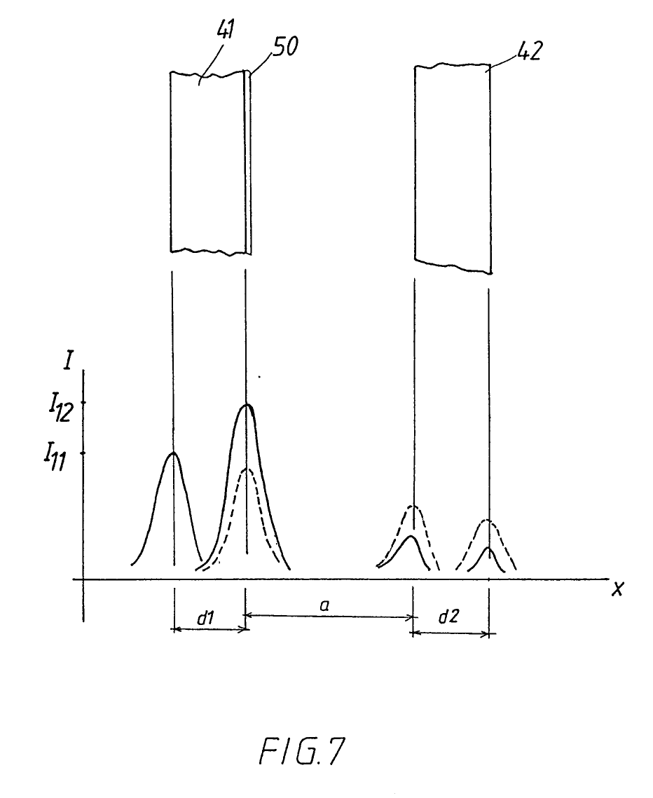

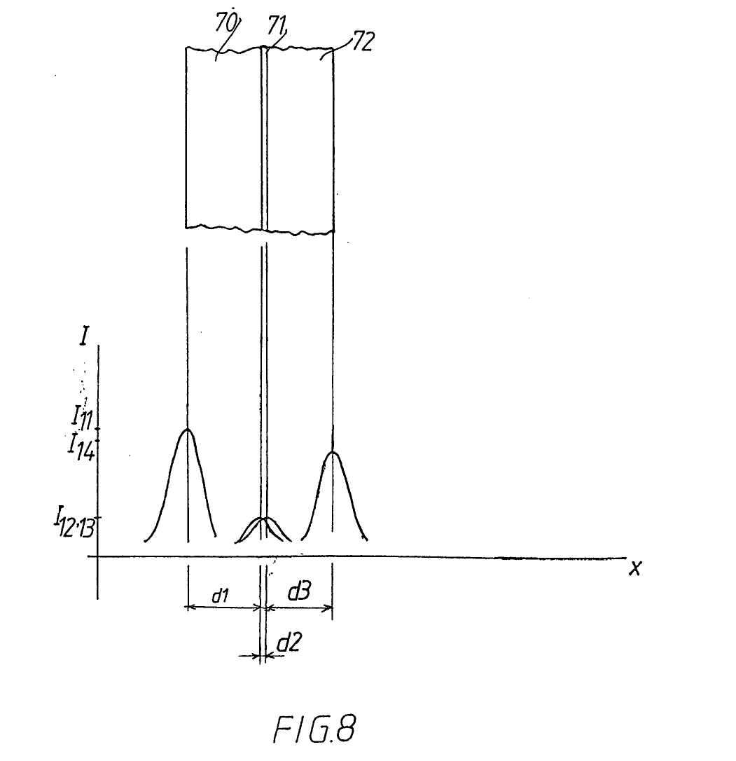

FIG. 7 is a schematic representation of the intensity dispersion of the beams reflected from a coated insulating glass element;

FIG. 8 is a schematic intensity dispersion of the beams reflected from a laminated glass; and

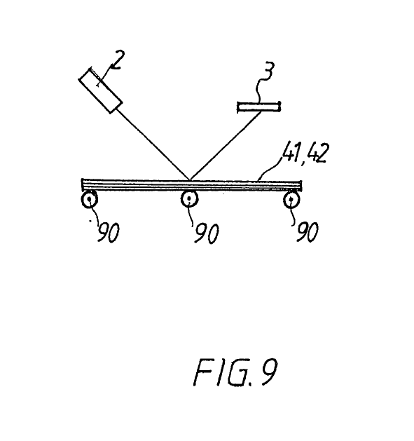

FIG. 9 is a schematic representation of a further embodiment of the device according to the present invention.

FIGS. 1 through 4 shows a device for inspecting and testing a insulating glass element 41, 42 made from two parallel glass panes, for example of an insulating glass window, a laminated glass, or a similar object made from glass, which can include also more than two parallel glass plates. Also, the testing of single glass panes is possible with this device. The state of the insulating glass after its manufacture or after its installation in buildings can be inspected and tested, in order to ensure, for example, that coatings were properly applied to the glass panes, and whether a hardening of the glass is actually provided and that unhardened glass was used in the manufacture of the insulating glass element. Likewise, the inspection of a laminated glass element is possible, in which, for example, between two parallel glass panes, a laminate film is adhered and whose existence can be determined with the inventive device.

One embodiment of the device includes a housing 1 that can be attached to one of the outer sides of the insulating glass element 41, 42 and a firs light source 2, preferably a laser light source 2, arranged in the housing 1, from which a downwardly directed light beam 10 can be emitted.

On the underside of the housing 1, a first perforation 60 for passage of the light beam 10 that can be emitted from the first light source 2 is provided, and the parallel light beams 11, 12, 13, 14 reflected from the insulating glass element 41, 42 is provided. To this purpose, however, also two or more perforations can be provided, as long as these do not hinder the passage of the emitted and reflected light.

The housing 1 has three support points (not shown in FIG. 3) on its underside, which permit the impingement of the light beam 10 in an essentially normal plane to the glass panes of the insulating glass element 41, 42 also with a lightly curved glass pane 41, which is a precondition for the correct functioning of the device.

According to the present invention, a position-resolving, opt-electronic detector 3 for determining the mutual distance of the reflected light beams 11, 12, 13, 14 and their intensities is provided.

Preferably, the opto-electronic detector is formed as a CCD (Charge Coupled Device) element 3 containing a plurality of image storage points 17 (FIG. 6), which are arranged within the housing 1 such that the light beams 11, 12, 13, 14 reflected from the insulating glass element 41, 42 impinges on the image storage points 17.

The inventive device can be used in particular for hardened, laminated, coated, and colored glass. It can be protected against faulty implementation by a further sensor, which determines whether a glass surface is located in the measured region.

The manner of functioning of the inventive device is shown with reference to the optical path shown in FIG. 5 by means of an insulating element formed from three parallel panes 41, 42, 43. In most cases, these panes are separated from one another by an intermediary space filled with an insert gas, whereby the passage of the emitted beam as well as reflection and refraction phenomena are to be observed. With multilayer glass, the distance between two glass panes also can be filled by a laminate foil. The device of the present invention can also be used with such insulating glass panes, as far as a change of the refraction index between to panes takes place.

The beam 10 impinging at an angle on the front side of the pane 41 is reflected in part, the reflected beam 11 impinges on the CCD element 3, which in the shown embodiment of the invention is a CCD line 3, in which the image storage points 17 are arranged linearly along the longitudinal axis of the CCD line 3, whereby the longitudinal axis of the CCD line 3 runs in the plane extending through the reflected light beam 10 and the further reflected light beams 11, 12, 13, 14, 15, 16, so that these impinged on the CCD line 3 and can be registered there.

In the embodiment according to FIG. 5, a metallic coating 50 is applied to the back side of the glass pane 41, which is common for insulating glass elements. The non-reflected part of the light beam 10 is refracted upon entry into the glass pane 41 corresponding to its refractive index and is reflected partially anew on the back side of the glass pane 41, whereby a light beam 12 that is reflected parallel to a reflected light beam 11 leaves the front side of the glass pane 41, which impinges on the CCD line 3 offset to the light beam 11, The further glass panes 42, 43 produced reflected beams 13, 14 or 15, 16 on their front and back sides in the same manner, which impinged on the CCD line 3 offset to one another, The multiple refraction of the reflected beams acting on the path of the CCD line 3 through the respective other glass panes of the insulating glass element is shown in FIG. 5.

By means of the coating 50 on the back side of the glass pane 41, the part of the light reflected on this coating 50 increases relative to an uncoated glass pane at this position.

The intensity increase of the reflective beam 12 occurring in this manner is portrayed in FIG. 7, in which the intensity I of the reflected light and the light impinging on the CCD line 3 is applied in dependence of the measured distance X along the CCD line 3. As shown in FIG. 7, the beam 11 reflected on the front side of the glass pane 41 provides a first intensity dispersion, whose maximum I₁₁ is smaller than the maximum I₁₂ of the reflected intensity dispersion on the back side of the glass pane 41 and the coating 50. The intensity maximum is provided in the distance of the glass thickness d1, which can be determined via the CCD line 3. The intensity course of an insulating glass element without coating 50 is shown in FIG. 7 in a dashed line.

It is important for this case to recognize smaller light intensities reflect on the back side of the glass pane 41. From this intensity difference, the presence of a metallic coating can be determined.

As is to be expected, the intensity of the light beams reflected on the second glass pane 42 without a coating 50 is higher than with a coating. Consideration must be given to this fact upon the evaluation of the measurement results. There are naturally complicated situations with multiple coated glass panes or the simple case of one coated single glass pane to be managed in an analogous manner.

Also, the mutual distance a of the glass panes 41, 42 and the thickness d2 of the glass pane 42 can be determined from the position of the intensity maximum.

From FIG. 6, it can be seen that this distance determination is based on a measuring principle, whereby each image storage point 17 of the CCD line 3 is associated with a location or spot coordinate. With an embodiment of the invention conforming to practice, the position resolution is approximately 0.05 mm.

The intensity dispersion produced from the reflected beams 11 and 12 are released via the image storage points 17 of the CCD line 3 in discrete intensity measuring points, from which the position and the height of the maximum I₁₁ and I₁₂ are determined.

The distance of the maximum makes possible the thickness determination and the determination of the mutual distance of the glass plates.

For processing of the intensity values provided from the measurement of the reflected light beams, the CCD line 3 is connected with an evaluation device 45 (FIG. 5), which, from the intensities of the reflected light beams 11, 12, 13, 14, 15, 16, determines the existence and the position of a coating 50 applied to the individual glass panes of the insulating glass element 41, 42, 43 measured in FIG. 5.

The evaluation device 45 is further connected with a display device 46, for example, an LCD display, via which the number, the thickness, the mutual distance of the parallel, glass panes and the position of a likewise provided coating on the front or rear side of the glass panes of the insulating glass element 41, 42, 43 or from one or more laminate foils contained in a laminated glass can be displayed with the assistance of graphical symbols. The display 46 is mounted on the upper side of the housing 1, whereby buttons 21, 22, 23 for operating the inventive device are provided (FIG. 1).

Since the device of the present invention should be portable, it is advantageous to form the first light source as a laser diode 2, for example, red light, <3 mW, whose optical axis preferably runs at an angle of 45° to 60°, preferably 52.5°, relative to the housing wall 61.

As shown in FIGS. 2 and 3, the first wall perforation 60 for passage of the light emitted from the laser diode 2 and reflected from the insulating glass element 41, 42 is rectangular. The CCD line 3 is arranged along a longitudinal central axis of the first wall perforation 60 and is vertically offset to the housing wall 61 containing the first wall perforation 60.

In order to shut off a glare effect—as viewed in the direction of the reflected beams 11, 12, 13, 14—an interference filter 67 is arranged at a distance from the CCD line 3, which under consideration of an angle of incidence of the reflected beams 11, 12, 13, 14, is permeable only for the wavelength of the light emitted from the first light source 2. It can be inserted in the first perforation 60.

A further spectral filter 66 can be arranged in the optical path of the light emitted from the laser diode 2 before its reflection by the insulating glass element.

Finally, the thickness of the housing wall 61 on the under side of the housing 1 is dimensioned to be greater than the opening width of the perforation 60 for passage of the light rays 11, 12, 13, 14, 15, 16 that are reflected back. In this manner, the infiltration of glare is limited. This is absorbed in part on the wall of the perforation 60.

In order to make visible the inner structure of an insulating glass element, in particular, for inspecting, whether this contains hardened glass panes or not, according to the present invention, a second light source 7 for emitting a flat or planar light field and a first light-polarization device 33, as well as a second light-polarization device 32, are provided, whereby the first light-polarization device 33 polarizes the light emitted from the second light source 7 and the second light-polarization device polarizes the light reflected from a single glass pane, from the insulating glass element 41, 42, or from a laminated glass.

The housing 1 therefore has in the shown embodiment a second perforation 80 for passage of the flat or planar light field that can be sent from the second light source 7 and a housing window 38 directed to the second housing perforation 80.

The most possible uniform illumination of the light field impinging on the insulating glass element 41, 42 is achieved, in that the second light source is formed as a preferably U-shaped fluorescent tube 7.

The first light-polarization device 33 is arranged in the region of the second light source 7 and the second light-polarization device 32 is arranged in the region of the housing window 38, whereby the first light-polarization device 33 polarizes light emitted from the second light source 7 and the second light-polarization device polarizes light reflected from the insulating glass element 41, 42, whereby, preferably, a linear polarization of the light is achieved. A circular polarization is also contemplated.

By means of a constriction of the light falling on the polarization plane by means of the first light-polarization device 33, determined regions of the light field upon the reflection from the insulating glass element 41, 42 are rotated, such that they come to lie exactly in the polarization plane of the second light-polarization device 32 and appear bright upon observation of the housing window 38. Other regions are turned away from this polarization plane and therefore appear dark.

Hardened glass, compared with unhardened glass, has a characteristic appearance upon observation under polarized light. Upon viewing the regions of the insulating glass element 41, 42 that are illuminated by the light field of the light source 7, it can be determined immediately, whether a hardened or an unhardened glass is present.

Preferably, the first light-polarization device is formed as a first pole filter 33 and the second light-polarization device is formed as a second pole filter 32.

The housing window 38 is provided in an angled housing wall 40 of the housing wall 1, preferably 45°, whereby the second pole filter 32 is countersunk in a first frame part 42 that runs parallel to the housing window 38. An observer, therefore, can very comfortably the illuminated filed on the insulating glass element 41, 42 through the angled side of the housing 1 and through the second perforation 80.

For receiving the first pole filter 33, in addition, in the interior of the housing 1, a second frame part 41 is arranged, whose plane is oriented at a right angle to the first frame part 42, so that the first and the second frame parts 42, 41 extend in a roof-like manner over the second perforation 80. The fluorescent tube 7 is arranged parallel to the plane of the second frame part 41. The second perforation 80 is covered by a protective glass 82.

FIG. 8 shows by way of example the structure of a laminated glass 70, 71, 72 and the intensity course resulting from the measurement with the device of the present invention. The laminated glass therefore comprises two glass plates 70, 72, for example, between which a laminate film 71 is adhered, which, for example, has only a 1/10 mm thickness and the opposite glass has only an insignificantly different refraction coefficient, such that the intensity of the light beams reflected on the transition from glass to film is relatively small.

As FIG. 8 shows, the beams reflected on the front side of the glass pane 70 and on the back side of the glass pane 72 provide an intensity dispersion, whose maximums I₁₁, and I₁₄ are much higher than the intensity maximums I₁₂, I₁₃ of the beams reflected on the front and back side of the central laminate film 71. Both of the latter maximums can be separately detected only with a very intense collimated laser beam; rather merely an individual maximum is provided, from which, however, at least the presence of a laminate film can be determined. If both intensities maximums are resolved, then the thickness d2 of the laminate film in addition to the thickness determination d1, d3 of both glass panes 71, 72 can be determined from their spacing.

FIG. 9 shows a further embodiment of the device of the present invention, in which, at a distance from the first light source 2, a transport device, here, backing rolls 90, is arranged, on which the single glass pane, insulating glass element 41, 42, or laminated glass can be moved, so that during the passing movement of the single glass pane, the insulating glass element, or the laminated glass to the first light source 2, this element moves into a reflection position and the reflected light beams impinge on the opto-electronic detector 3.

Analogously, also the second light source 7, the first light-polarization device 33, as well as the second light-polarization device 32 can be arranged at a distance relative to the transport device 90.

1. A device for inspecting and testing a single glass pane, an insulating glass element (41, 42, 43) having two or more parallel glass panes, for example, an insulating glass window, or a laminated glass (70, 71, 72), with a first light source (2) for production of a collimated laser beam, whose optical axis can be brought in a reflection position with the single glass pane, the insulating glass element (41, 42, 43), or the laminated glass (70, 71, 72) and an oppositely arranged, fixed optical unit for determining the mutual distance of the parallel laser beams (11, 12, 13, 14, 15, 16) reflected from the single glass pane, the insulating glass element (41, 42, 43), or the laminated glass (70, 71, 72) and an evaluation device (45), whereby the optical unit for determining the mutual distance of the reflected laser beams (11, 12, 13, 14, 15, 16) is formed by a position-resolving opto-electronic detector (3), which is connected with the evaluation device (45), wherein the evaluation device is arranged such that it can determine the thickness of the single glass pane, the thickness of individual glass panes of the insulating glass element (41, 42, 43) or the thickness of layers of the laminated glass (70, 71, 72) and their mutual distances from the distances and intensities of the reflected laser beams (11, 12, 13, 14, 15, 16), characterized in that the evaluation unit is arranged such that it determines the existence and the position of a coating (50) applied to the single glass pane or the individual glass panes of the insulating glass element (41, 42, 43) or of one or more laminate films (71) contained in the laminate glass (70, 71, 72) from the intensities of the reflected laser beams.

2. The device according to claim 1, characterized in that a transport device is arranged at a distance from the first light source (2), on which the single glass pane, insulating glass element, or laminated glass can be moved, so that during a passing movement of the single glass pane, the insulating glass element (41, 42), or the laminated glass to the first light source (2), the single glass pane, the insulating glass element (41, 42), or the laminated glass moves into a reflection position and reflected laser beams impinge on the opto-electronic detector (3).

3. The device according to claim 1, characterized in that the device is arranged in a housing that can be attached to an outer side of the single glass pane, the insulating glass element (41, 42, 43), or the laminated glass (70, 71, 72), wherein in the housing (1), at least a first perforation (60) is provided for passage of a laser beam emitted from the first light source (2) and the laser beams (11, 12, 13, 14, 15, 16) reflected from the single glass pane, the insulating glass element (41, 42, 43), or the laminated glass (70, 71, 72).

4. The device according to claims 1, 2, or 3, characterized in that the opto-electronic detector is formed as a CCD (Charge Coupled Device) element (3) containing a plurality of image storage points (17), and that the laser beams (11, 12, 13, 14, 15, 16) reflected from the single glass pane, from the insulating glass element (41, 42, 43) or from the laminated glass impinge on the image storage points (17).

5. The device according to claim 4, characterized in that the CCD element is formed as a CCD line (3), in which the image storage points (17) are arranged linearly along a longitudinal axis of the CCD line (3), and that the longitudinal axis of the CCD line (3) runs in the plane extending through the reflected laser beams (11, 12, 13, 14, 15, 16).

6. The device according to one of claims 3 through 5, characterized in that the at least one first perforation (60) for passage of the laser beam (10) that can be emitted from the first light source (2) and the laser beams (11, 12, 13, 14, 15, 16) reflected back from the single glass pane, from the insulating glass element (41, 42, 43), or from the laminated glass (70, 71, 72)—in a known manner—is provided in a housing wall (61) on an underside of the housing (1), and that the optical axis (10) of the first light source (2), preferably runs in an angular range of 45° to 60°, relative to the housing wall (61).

7. The device according to one of the preceding claims, characterized in that the first light source is a laser diode (2).

8. The device according to claim 5, characterized in that the first wall perforation (60) is rectangular, and that the CCD line (3) is arranged along a longitudinal central axis of the first wall perforation (60) and is vertically offset to the housing wall (61) out of which the first wall perforation (60) is formed.

9. The device according to one of the preceding claims, characterized in that the evaluation device (45) is connected with a display device (46), via which the number, the thickness, the mutual distance of the parallel glass panes and the position of a coating on the front or back side of the single glass pane or the glass panes of the insulating glass element (41, 42, 43) or the number and thickness of the laminate films (71) of the laminated glass (70, 71, 72) can be displayed.

10. The device according to claim 5, characterized in that an interference filter (67) is arranged at a distance in front of the CCD line (3), as viewed in a direction of the reflected beams (11, 12, 13, 14), wherein the interference filter (67) is only permeable for the wavelength of the light that can be emitted from the first light source (2), under consideration of the angle of incidence of the reflected beams (11, 12, 13, 14).

11. The device according to one of claims 8 through 10, characterized in that a thickness of the housing wall (61) on the underside of the housing (1) is greater than an opening width of a wall perforation for passage of the laser beams (11, 12, 13, 14, 15, 16) that are reflected back.

12. The device according to one of claims 1 through 11, characterized in that a second light source (7) for emitting a planar light field and a first light-polarization device (33), as well as a second light-polarization device (32) are provided, wherein the first light-polarization device (33) polarizes light emitted from the second light source (7) and the second light-polarization device (32) polarizes light reflected from the single glass pane, from the insulating glass element (41, 42), or from the laminated glass (70, 71, 72).

13. The device according to claim 12, characterized in that at a distance from the first light source (2), a transport device is arranged, on which the single glass pane, insulating glass element, or laminated glass can be moved, so that during a passing movement of the single glass pane, the insulating glass element, or the laminated glass, the planar light field that can be sent from the second light source (7) impinges on the glass surface.

14. The device according to claim 13, characterized in that it includes a housing (1) that can be attached to an outer side of the single glass pane, the insulating glass element (41, 42) or the laminated glass (70, 71, 72), that the housing (1) has at least a second perforation (80) for passage of a planar light field that can be sent from a second light source (7) and the first light-polarization device (33) is arranged in a region of the second light source (7), and that a housing window (38) that is directed toward the second housing perforation (80) is provided, in which region a second light-polarization device (32) is arranged.

15. The device according to claim 14, characterized in that the second light source is formed as a preferably U-shaped fluorescent tube (7).

16. The device according to claim 14 or 15, characterized in that the first light-polarization device is formed as a first pole filter (33) and the second light-polarization device is formed as a second pole filter (32).

17. The device according to claim 16, characterized in that the housing window (38) is formed in an angled housing wall (40) having an angle of preferably 45°, and that the second pole filter (32) is countersunk in a first frame part (42) running parallel to the housing window (38).

18. The device according to claims 16 or 17, characterized in that in the interior of the housing (1), a second frame part (41) for receiving the first pole filter (33) is arranged, whose plane preferably is oriented at a right angle to the first frame part (42), so that the first and the second frame part (42, 41) extend in the manner of a roof over the second perforation (80).

19. The device according to claim 15, characterized in that the fluorescent tube (7) extends parallel to a plane of the second frame part (41).
